(19) United States
(12) Patent Application Publication
(10) Pub. No.: US 2014/0305119 A1
(43) Pub. Date: Oct. 16, 2014

(54) METHOD AND SYSTEM FOR CONNECTING BUOYANT MEMBERS

(71) Applicant: GREY ISLAND ENERGY INC., St. John's (CA)

(72) Inventors: Brian LUNDRIGAN, Conception Bay South (CA); Tim GARDINER, St. John's (CA)

(73) Assignee: GREY ISLAND ENERGY INC., St. John's (CA)

(21) Appl. No.: 14/247,316

(22) Filed: Apr. 8, 2014

Related U.S. Application Data
(60) Provisional application No. 61/810,402, filed on Apr. 10, 2013.

(51) Int. Cl. F03B 13/18

(52) U.S. Cl. CPC F03B 13/182
USPC 60/499

(57) ABSTRACT

A method and system of connecting buoyant members of an Attenuator type Wave Energy Converter (WEC) for converting the energy of water waves to electricity. By coupling a joint between two buoyant members of the WEC into the hull of one of the members, removes the joint from the exposure of the elements, slowing down the wear and tear on the joint from wind, sun and water. Furthermore, any required repair of the joint occurs in the substantially dry hull of one of the members reducing the need for the repair to be conducted in water. The joint keeps the members linked during heave, roll and yaw forces placed on the linked members by the moving water.

### FIELD OF INVENTION

The present invention relates to Wave Energy Conversion (WEC), particularly to ocean-going WEC applications.

### BACKGROUND

The capture of kinetic energy from ocean waves for transmission and use in shore-based applications is a well-known art with origins reaching as far back as the 18th century, and the conversion of that energy in-situ into electricity began in the early 20th century, although attempts to develop the technology into large-scale real world applications did not begin in earnest until the energy crisis of the mid-1970's. Ocean power represents a renewable, domestic energy source with minimal ecological impact, and so with renewed interest in so-called “green energy”—e.g., solar power, wind energy—there has been a concurrent effort of late to develop WEC as an efficient, commercializable source of power generation.

WEC applications come in a variety of shapes and forms, including some very large shore-based installations, but the two most popular formats—the Point-Absorber and the Attenuator—are based around the same core working principle: relational motion between two bodies provided by oncoming ocean waves is captured by a power take-off device and either converted directly to electricity or transmitted elsewhere for conversion. Point-Absorber systems consist of individual buoy-type devices moored to the sea-floor, and are generally designed to capture the vertical motion of the buoyant body in relation either to the stationary mooring device or a secondary subsea body. The Attenuator, on the other hand, is comprised of an articulated series of elongate, floating members, also usually moored to the ocean floor, and positioned parallel to prevailing, oncoming waves; the power take-off device in this case usually occurs between the individual members of the linear system, capturing the energy as each member moves in relation to the next member of the series. In many of these applications, the power take-off device is an hydraulic ram or series thereof, but can be any number of energy conversion methods, such as linear motors, generators, or other mechanisms for capturing such energy.

Although Point-Absorbers are popular applications, the Attenuator style application has reached a level of technological refinement close to that required for governments—local, regional and national—to make large-scale infrastructure investments in the development of offshore wave energy farms; indeed, the British and Portuguese governments have already made significant investments in such devices which currently provide power to their respective national power grids. For governments and other bodies which are spending money on these applications, however, survival is a key concern. As major infrastructure investments in the local power grid, WEC farms must be built to survive for decades.

Complicating the issue of survival is the fact that a single module of a typical Attenuator type application can weigh hundreds of tons, including the hull of the module, the power take-off equipment, and any conversion and/or transmission equipment. Any malfunction that requires the affected module to be returned to shore for repair incurs serious costs in both time and money as the unit is unmoored, removed from the water, repaired and/or replaced.

The most common hazard for these installations is the heavy sea states associated with inclement weather and high winds. In heavy sea states, wave action is not only parallel to the orientation of the linear system, but may also strike individual modules in the linear system along any number of paths; the articulated members of the system must therefore be joined in some way to allow the system to move not only with the heave of oncoming perpendicular waves, but also with the yaw associated with lateral wave action, as well as the potential for the individual modules to roll axially. There must also be allowances made in the articulation of the system for the application of restoring force, which acts to restore the system to a more or less straight line facing the prevailing wave action. In addition, these non-perpendicular wave motions are common during less tumultuous sea states, and so multiple modules of the linear system may be designed for energy conversion as well as energy dissipation of these wave actions in order to maximize energy capture and ensure survivability.

The current state of the art addresses these issues by articulating the linear system chain of modules in such a fashion that movement along a number of planes is possible, and the power take-off devices are arranged so as to collect the energy expended by wave action along some of these planes. The usual method of doing so is by arranging a number of linkage points around the exterior circumference of the hull of each module, fore and aft, these linkage points are usually paired diametrically opposite one another along at least two axes to provide range of motion for both heave and yaw. At each point is a power take-off device, which may or may not also provide restoring force to the column.

One piece of prior art is an elongate Attenuator style application, wherein each module is connected to the next consecutive module at evenly spaced points around the circumference of the hull. These connections are comprised of hydraulic ram take-off devices arranged in such a way as to provide two axes of movement—pitch and yaw—for the device, and collect the energy generated by the relative motion between the modules.

There are, however, several issues related to this solution, i.e., a plurality of connection points located externally around the circumference of the hull. The biggest issue is that the opportunities for mechanical failure increase with the number of connection points—the more connections that exist, more failures may occur. Moreover, because the connection points are located externally to the hull, those connections must be over-built for the purposes of day-to-day survival and consequently expensive to replace. In addition, at least one of those connection points will be submerged under the water during normal operations; to allow lateral movement (left and right between interconnected modules/yaw), one connector must be located somewhere at the bottom of the vertical axis. If there is a failure at that point, then the entire module must be removed from the water, towed to shore, and repaired in a dry dock. This is a time-consuming and expensive effort, one which is increased when the connector that is to be replaced is a specialized device for external use. Furthermore, there may be more than one connection below the water line. It is possible, for example, that the connectors will not be located on the direct vertical and horizontal axes, but on a bias, placing perhaps two of the connectors underwater—this arrangement is to provide a restoring force to the module, permitting it to return to a neutral position after being displaced by wave action—which again increases the chances of a critical failure requiring the entire linear system to be returned to shore for repair.

It would be advantageous to overcome some of the disadvantages of the prior art.

### SUMMARY OF THE EMBODIMENTS OF THE INVENTION

In accordance with an aspect of at least one embodiment of the invention there is provided a system comprising a power take-off module for converting relative motion between a first element and a second element into energy; a hull for providing buoyancy in a fluid, the hull enclosing the power take-off module for protecting the power take-off module from damage by the fluid; and a coupling for coupling the power take-off module between the first element and the second element.

In accordance with an aspect of at least one embodiment of the invention there is provided another second element comprising an elongate member coupled to a buoyant body; a first element comprising a hull and a power take off module, the hull for providing buoyancy in a fluid, the hull enclosing the power take-off module for substantially protecting the power take-off module from damage by the fluid, the power take off module for converting relative motion between the first element and the joint into energy, a coupling comprising a joint for coupling the power take-off module between the first element and the second element, the joint having a connecting element for coupling to the elongate member and providing degrees of freedom for roll, heave and yaw, the joint for being coupled with the first element for supporting relative motion therebetween; and wherein in use the hull and the coupling cooperate to provide fluid-resistance for protecting the power take-off module from damage by the fluid.

In accordance with an aspect of at least one embodiment of the invention there is provided a method comprising enclosing a power take off module in a hull to provide buoyancy in a fluid and to substantially protect the power take off module from the fluid; coupling the power take off module between a first element and a second other element via a joint, the joint providing degrees of freedom for roll, heave and yaw of the second element in a manner that does not generate electricity from motion along the provided degrees of freedom; and generating electricity from the relative motion of the first element relative to the second element the relative motion between the joint and the power take off module.

### BRIEF DESCRIPTION OF THE DRAWINGS

FIG. 1 is an illustration of the connecting member and second module.

FIG. 2 is a side-view of the connecting member.

FIG. 3 is a cutaway view of the first part of the joint assembly.

FIG. 4 is a side view of the first part of the joint assembly and the connecting member.

FIG. 5 is a front view of the second part of the joint assembly.

FIG. 5a is a side view of the second part of the joint assembly.

FIG. 6 is a bias front view of the third part of the joint assembly.

FIG. 6a is a top view of the third part of the joint assembly.

FIG. 7 is a bias front view of the fourth part of the joint assembly.

FIG. 8 is a front view of the second, third and fourth parts of the joint assembly assembled.

FIG. 9 is a side cutaway view of the second, third and fourth parts of the joint assembly assembled.

FIG. 10 is a top cutaway view of the second, third and fourth parts of the joint assembly assembled.

FIG. 11 is a front view of the cylindrical cup.

FIG. 12 is a front view of the joint assembly connected to power take-off devices and power transfer structure assembly.

FIG. 13 is a side view of the joint assembly connected to power take-off devices and power transfer structure assembly.

### DETAILED DESCRIPTION OF THE EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

The present description discloses a method and system for linking two members of an Attenuator type WEC device. A connecting member connected to the front end of the second member extends into the body of the first member via an aperture; inside the body of the first member, the end of the connecting member is connected to at least one joint which permits motion along a plurality of axes, wherein that joint is connected to a plurality of power take-off devices located inside the body of the first member that in-turn converts the motion generated by wave action along any of the plurality of axes into usable energy. The present description also discloses reducing the number of connection points, and moving the reduced number of connection points to the interior of the floating member, where the connection can be more easily serviced without removing the floating member from the water: there are fewer opportunities for failure, and if the connection fails, the floating member can be serviced while at sea as repairs can be carried out within the hull of the floating member. Placing the connection interior to the hull decreases the need to overbuild the power take-off devices for survivability in the elements. Located within the relative safety of the hull, off-the-shelf power take-off devices can be used, reducing not only the cost and time to produce the member, but also the cost and complexity of repair should a failure occur.

An illustrative embodiment of the present invention will now be described, wherein like parts are indicated by like reference numbers. It should be noted that this illustrative embodiment is provided for exemplary purposes only and is not intended to limit the scope of the invention.

The survivability and flexibility of an Attenuator type WEC installation is augmented by reducing the number of connection points between a first member of an Attenuator type WEC installation (Attenuator) and a second member, as well as moving the connection point from the surface of the second member's hull to the inside of the first member. At the connection point internal to the first member, a connecting member of the second member is attached to a joint which permits movement in a plurality of planes of motion. In the illustrative embodiment the connecting member is configured for a range of motion in three planes—vertical, lateral and axial.

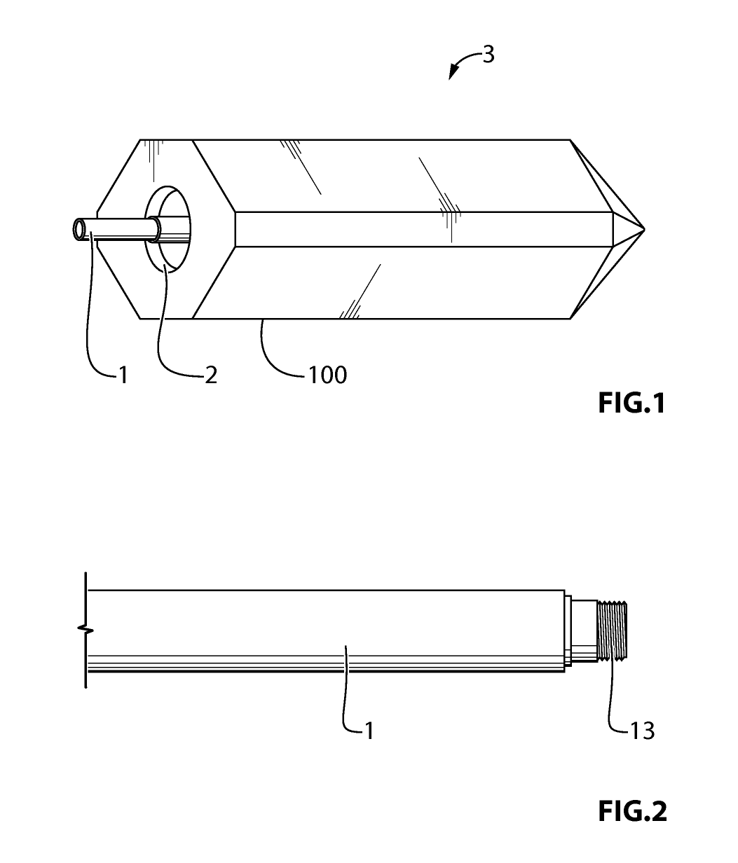

Shown in FIG. 1 is the connecting member 1 entering the aperture 2 in the hull 100 of the first member 3 of an Attenuator; the aperture 2 is of sufficient size to permit a range of motion in the desired plurality of axes, allowing an angle of deviation from the Attenuator's longitudinal axis in all desired axes of motion, providing flexibility to the Attenuator as a whole. FIG. 2 illustrates the connecting member 1 with a threaded end 13 as it is prior to insertion into the joint assembly (not shown) within the hull 100 of the first member 3. In this embodiment, the connecting member 1 is comprised of a tie rod. Alternatively, although coupled to the hull 100, the aperture 2 is flexible.

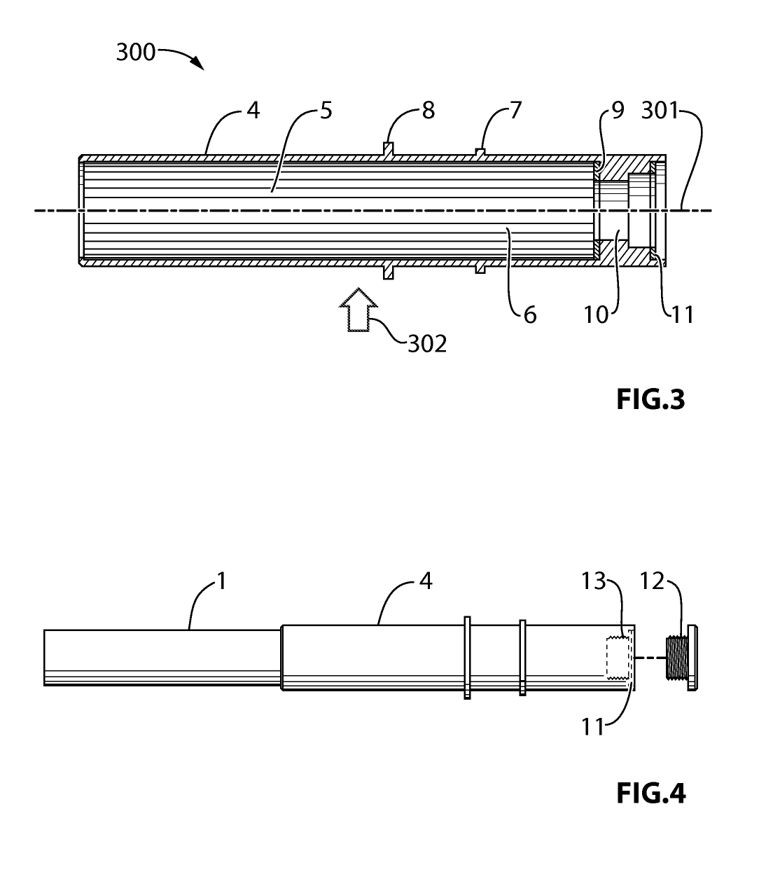

Referring now to FIG. 3, shown is first joint assembly portion 300. Joint assembly portion 300 permits motion around the longitudinal axis 301 of the Attenuator, or roll, caused by wave action striking a first member along the broadside of the first member hull as indicated by the direction of arrow 302. In this illustrative embodiment, joint assembly portion 300 is comprised of a substantially cylindrical body 4 which houses a shaft bearing 5 that facilitates motion of the connecting member within the cylindrical body 4. The shaft bearing 5 is grooved with grooves 6 to permit the free passage of water, which lubricates the shaft bearing 5. The exterior of the cylindrical body 4 features a set of flanges 7 and 8 which permit joint assembly portion 300 to be bolted to the rest of the joint assembly and power transfer structure (not shown); at the end of the shaft bearing 5 is a thrust bearing 9, which facilitates motion along the longitudinal axis 301 while alleviating some of the compression force that occurs along the longitudinal axis 301 as the second member moves vertically under the force of wave action, and a “stuffing box” 10—a gland seal assembly which prevents water from leaking out of the shaft of the cylindrical body 4 and into the hull of the first member; coupled to the “stuffing box” 10 is a second thrust bearing 11 which alleviates expansion forces which occur along the longitudinal axis 301 of the Attenuator as the first member moves vertically under the force of wave action.

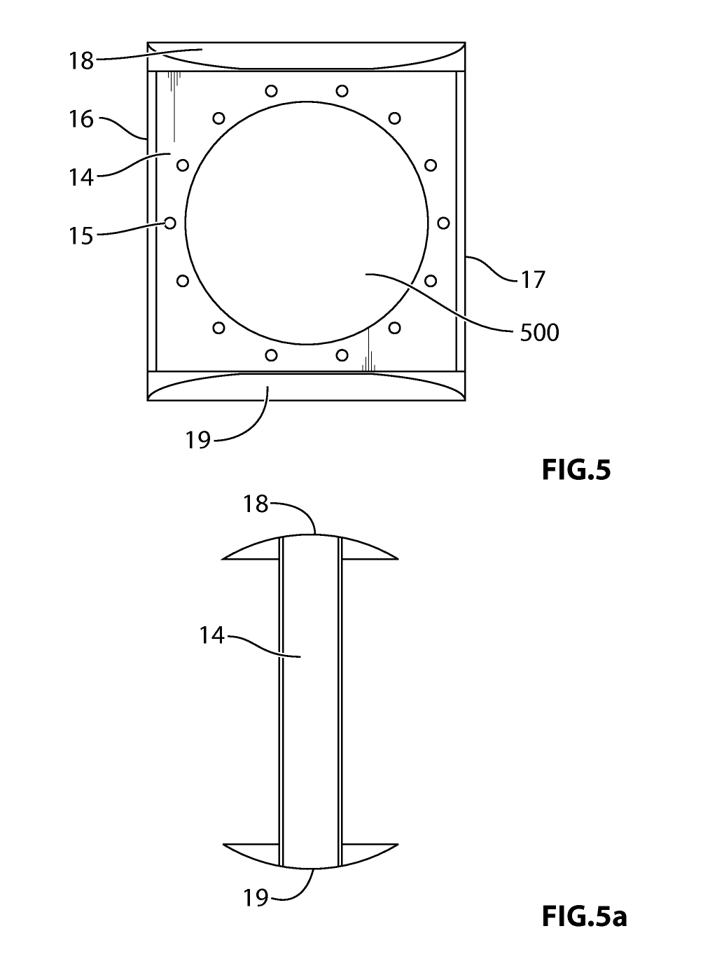

As illustrated in FIG. 4, connecting member 1 is inserted in the cylindrical body 4, and an end-cap 12 is screwed onto the threaded end 13 of the connecting member 1; the end cap 12 also secures the second thrust bearing 11. The joint assembly (not shown) that permits motion in the non-longitudinal axes is assembled around the cylinder 4 and mounts to flange 8. Although the illustrative embodiment features a specialized joint assembly in FIGS. 5, 6, 7, and 8, the joint assembly in other embodiments of the invention optionally features a simple or modified universal joint, or a ball joint.

A second portion of the joint assembly, joint assembly portion 14 as shown in FIG. 5, is coupled to the cylindrical body 4 by means of sliding cylindrical body 4 into the joint assembly portion 14 and bolting onto flange 8 via a series of holes 15 around an aperture 500 in the joint assembly portion 14. Joint assembly portion 14 is substantially rectangular, featuring four sides at 90 degree angles comprising one set of parallel sides 16 and 17 are substantially flat so that they may be better secured in the third portion of the joint assembly (not shown). The other set of parallel sides 18 and 19 are convex. FIG. 5a is a side view of joint assembly portion 14, featuring convex edges 18 and 19. When joint assembly portion 14 is nested within the third part of the joint assembly, these convex edges will behave as a bearing, allowing motion along one of the desired planes—in this embodiment, vertical motion, or heave.

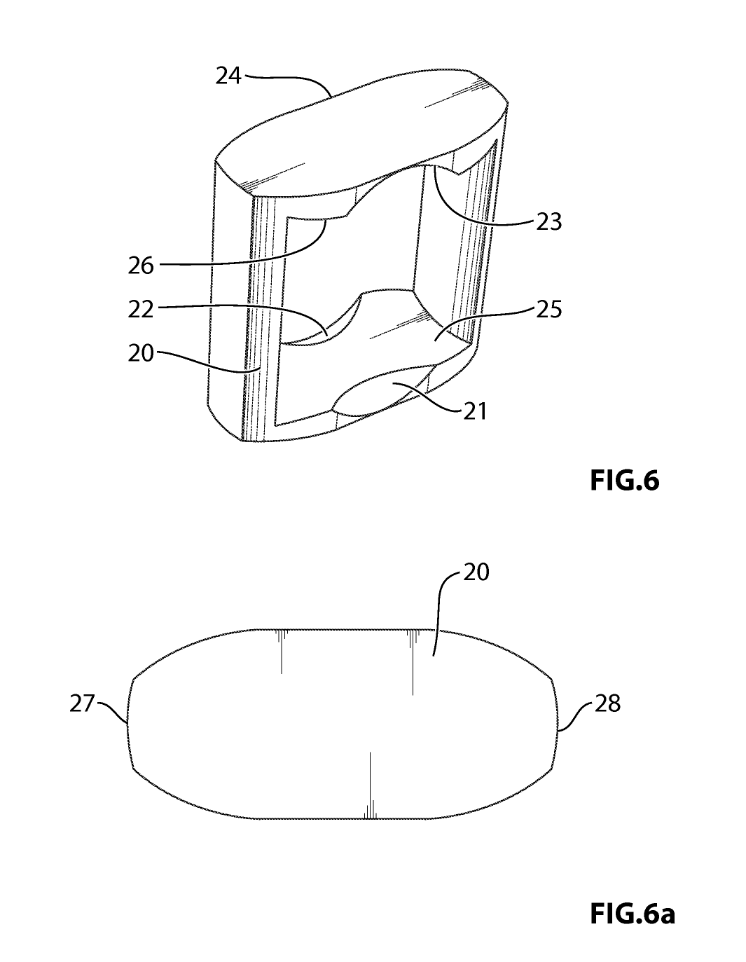

As illustrated in the bias front view in FIG. 6, the third portion of the joint assembly, joint assembly portion 20, features six concave surfaces 21, 22, 23, 24, 25, and 26. Concave surfaces 21, 22, 23 and 24 comprise a groove which permits further range of motion of the joint assembly portion 4. When joint assembly portion 14 is nested within joint assembly portion 20, edges 18 and 19 mate with concave surfaces 25 and 26, permitting motion along the vertical plane. In the top view of joint assembly portion 20 featured in FIG. 6a, it is shown that joint assembly portion 20 also comprises a pair of convex surfaces 27 and 28 along the outside edge. Surfaces 27 and 28 are positioned orthogonally to the convex surfaces 17 and 18, and when nested within the fourth part of the joint assembly will act as a bearing, allowing motion along another of the desired planes—in this embodiment, lateral motion, or yaw.

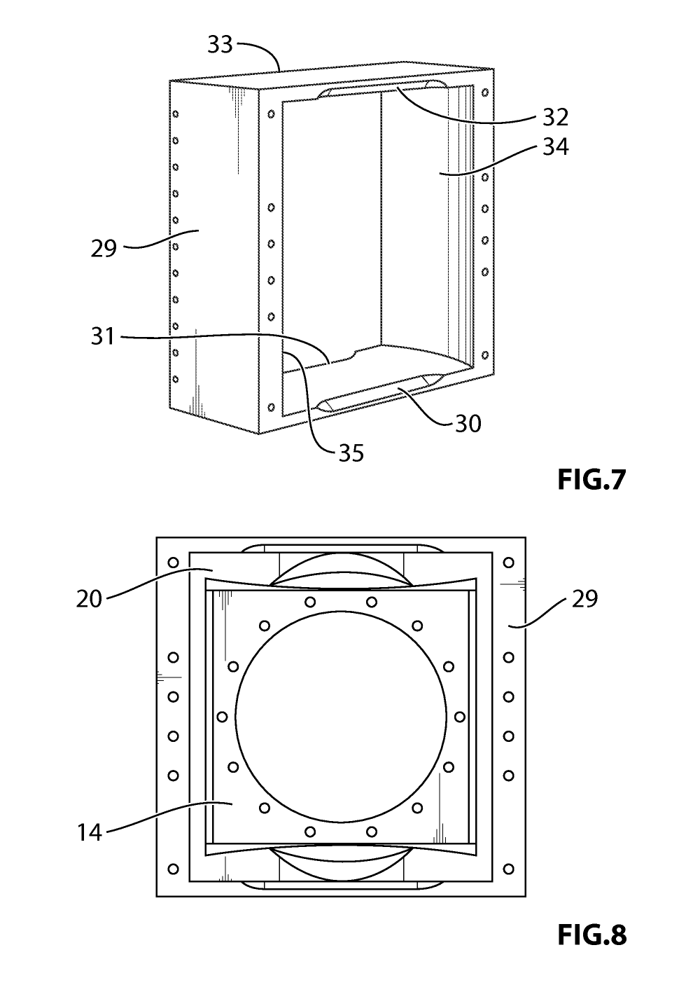

The fourth part of the joint assembly, joint assembly portion 29, illustrated in bias front view in FIG. 7, comprises six concave surfaces 30, 31, 32, 33, 34, 35. Each of the six concave surfaces comprises a groove which permits further range of motion of joint assembly portion 4. As shown in FIG. 8 grooves 30, 31, 32 and 33 work together with concave surfaces 21, 22, 23, and 24 to allow further range of motion of the fourth part of the joint assembly. When the joint assembly portion 20 is nested within the joint assembly portion 29, edges 27 and 28 mate with concave surfaces 34 and 35, permitting lateral motion of connecting member 1.

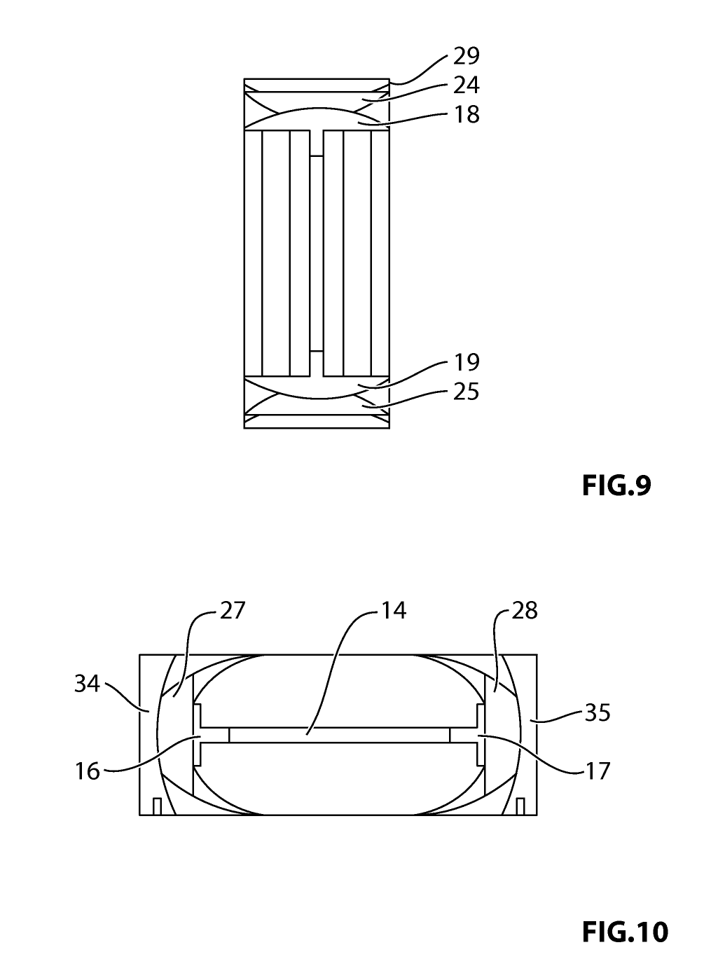

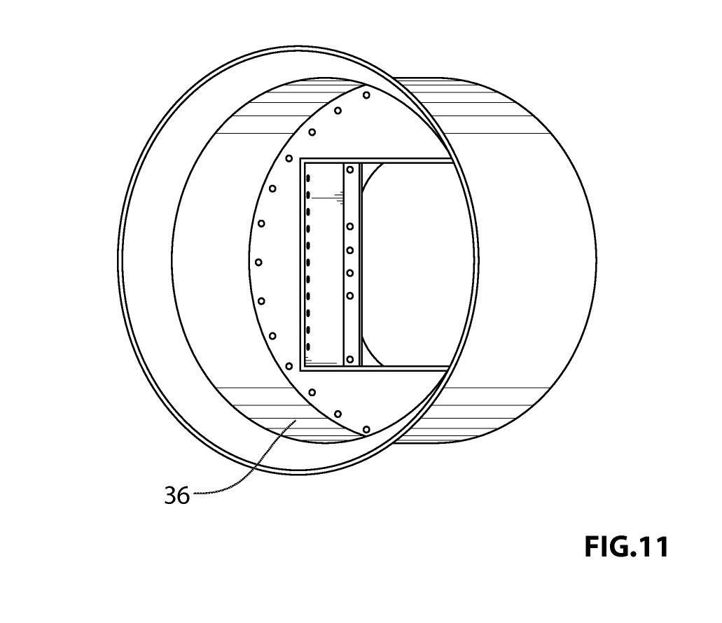

Joint assembly portions 14, 20 and 29, and the nature of their nesting is fully illustrated in FIGS. 8, 9 and 10 for the purposes of clarity. The joint assembly portions 14, 20 and 29 are housed within a large cylindrical cup 36, as shown in FIG. 11, the open end of which is the same diameter as the aperture 2 in the hull 100 of the second member 3. Optionally, the large cylindrical cup 36 houses a rubber bladder (not shown) to provide a watertight seal protecting the joint assembly and energy capture devices.

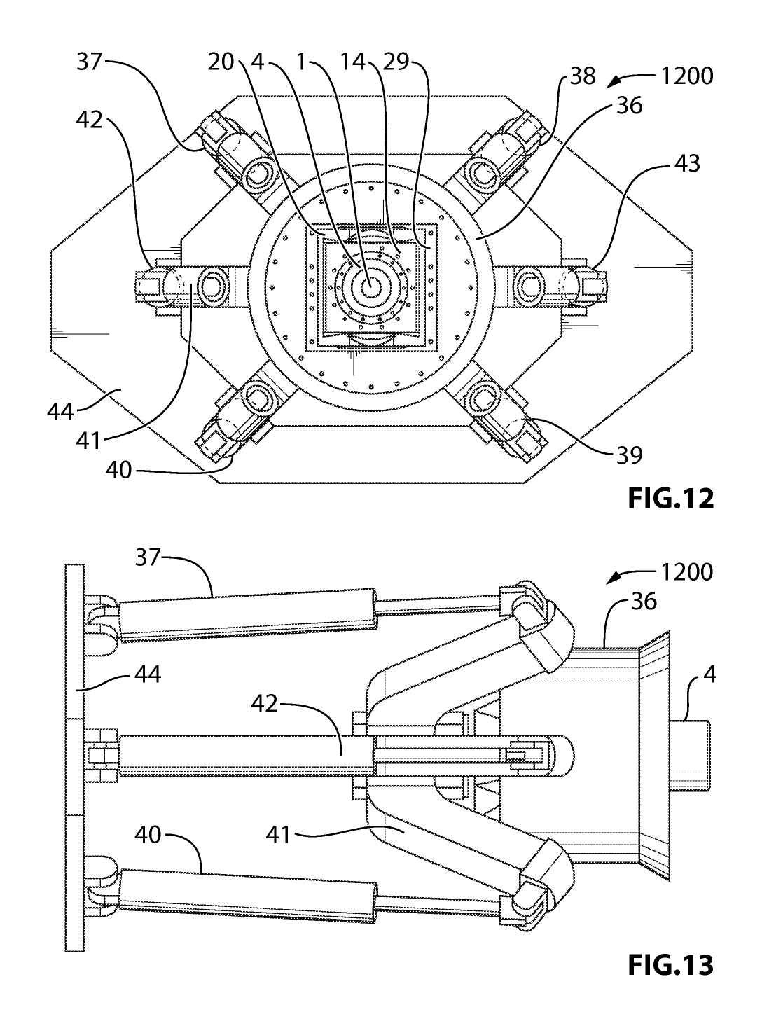

FIGS. 12 and 13, illustrate an assembled power capture system 1200. Power capture system 1200 is an example of a power capture assembly within hull 100 of first member 3. The cylindrical cup 36 and bulkhead 44 are for attaching this complete assembly to the hull 100 of the second member 3. Power transfer structure 41 is affixed to cylindrical body 4 via flange 7 and the extremities of the power transfer structure 41 arms are in turn attached to the energy capture devices 37, 38, 39 and 40; in this embodiment, energy capture is performed by a series of hydraulic rams in orthogonal pairs. The opposite ends of the energy capture devices 37, 38, 39 and 40 are connected to bulkhead 44 which is a fixed component of hull 100 of first member 3. The two hydraulic rams pictured 42 and 43 provide restoring force when the Attenuator is moved out of position laterally. Other embodiments of the invention may provide for energy capture along all planes of motion permitted by the joint assembly.

The embodiments presented are exemplary only and persons skilled in the art would appreciate that variations to the embodiments described above may be made without departing from the scope of the invention

What is claimed is:

1. A system comprising:
a power take-off module for converting relative motion between a first element and a second element into energy;
a hull for providing buoyancy in a fluid, the hull enclosing the power take-off module for protecting the power take-off module from damage by the fluid; and
a coupling for coupling the power take-off module between the first element and the second element.

2. A system according to claim 1 wherein the first element comprises the hull.

3. The system according to claim 1 wherein the power take-off module comprises a biasing mechanism for biasing the first element and the second element to a neutral position.

4. A system according to claim 1 wherein the second element comprises a first elongate member for transferring motion from a buoyant module.

5. The system according to claim 1 wherein the coupling comprises a joint.

6. The system according to claim 5 wherein the joint provides degrees of freedom for roll.

7. The system according to claim 6 wherein the joint comprises a connecting element having a longitudinal axis, the connecting element for coupling the second element to the joint.

8. The system according to claim 7 wherein the connecting element rotates about the longitudinal axis for accommodating rolling of the second element.

9. The system according to claim 8 wherein the hull comprises an aperture for disposing at least a portion of the coupling therethrough.

10. The system according to claim 5 wherein the joint provides degrees of freedom for yaw.

11. The system according to claim 5 wherein the joint provides degrees of freedom for heave.

12. The system according to claim 5 wherein the joint comprises:
a connecting element for coupling with the second element;
a shaft bearing disposed within the connecting element;
a lubricating fluid lubricating the shaft bearing within the connecting element; and
a fluid-resistant mechanism for restricting the lubricating fluid from leaking out of the connecting element.

13. The system according to claim 12 wherein the joint comprises:
a first body rotatable about a first axis of rotation for being linked to the second element and for supporting relative roll of the second element about the first axis of rotation;
a second body supporting the first body and rotatable about a second axis of rotation for supporting at least one of relative yaw and relative heave of the second element about the second axis of rotation;
a third body for supporting the second body and rotatable about a third axis of rotation for supporting at least the other of relative yaw and relative heave of the second element about the third axis of rotation; and
a housing for supporting the third body and for supporting the relative motion of the first element to the second element.

14. The system according to claim 13 wherein the first body is cylindrically shaped and coupled to the second body, the second body comprises a first plate and is nested in the third body, and the third body comprises a second plate and is nested in the housing.

15. The system according to claim 14 wherein the second body glides within the third body and the third body is hingedly connected to the housing.

16. The system according to claim 13 wherein the housing supports N pistons.

17. The system according to claim 16 wherein M of N pistons are power take off pistons.

18. The system according claim 17 wherein N−M pistons are biasing pistons for biasing the first element and second element to a neutral position.

19. The system according to claim 17 wherein M is 4 and N is 6.

20. The system according to claim 16 wherein the pistons are hingedly connected to a base plate.

21. The system according to claim 20 wherein the base plate is fixed in place relative to the hull.

22. The system according to claim 5 wherein the joint is fluid-resistant for protecting the joint from damage by the fluid.

23. The system according to claim 1 wherein in use the hull and the coupling cooperate to provide fluid-resistance for protecting the power take-off module from damage by the fluid.

24. The system according to claim 1 wherein the first element comprises a second elongate member for transferring motion from the buoyant module.

25. A system comprising:
a second element comprising an elongate member coupled to a buoyant body;
a first element comprising
a hull and a power take off module, the hull for providing buoyancy in a fluid, the hull enclosing the power take-off module for substantially protecting the power take-off module from damage by the fluid, the power take off module for converting relative motion between the first element and the joint into energy,
a coupling comprising a joint for coupling the power take-off module between the first element and the second element, the joint having a connecting element for coupling to the elongate member and providing degrees of freedom for roll, heave and yaw, the joint for being coupled with the first element for supporting relative motion therebetween; and
wherein in use the hull and the coupling cooperate to provide fluid-resistance for protecting the power take-off module from damage by the fluid.

26. A method comprising:
enclosing a power take off module in a hull to provide buoyancy in a fluid and to substantially protect the power take off module from the fluid;
coupling the power take off module between a first element and a second other element via a joint, the joint providing degrees of freedom for roll, heave and yaw of the second element in a manner that does not generate electricity from motion along the provided degrees of freedom; and
generating electricity from the relative motion of the first element relative to the second element the relative motion between the joint and the power take off module.
